(19) United States
(12) Patent Application Publication
(10) Pub. No.: US 2019/0103609 A1
(43) Pub. Date: Apr. 4, 2019

(54) NONAQUEOUS ELECTROLYTE SECONDARY BATTERY AND MANUFACTURING METHOD THEREFOR

(71) Applicant: SANYO Electric Co., Ltd., Osaka (JP)

(72) Inventors: Shinichi Yamami, Hyogo (JP); Kentaro Takahashi, Hyogo (JP)

(73) Assignee: SANYO Electric Co., Ltd., Osaka (JP)

(21) Appl. No.: 16/134,276

(22) Filed: Sep. 18, 2018

(30) Foreign Application Priority Data
Sep. 29, 2017 (JP) 2017-189364

(51) Int. Cl. H01M 4/587; H01M 4/36; H01M 10/0525; H01M 10/0568; H01M 10/058

(52) U.S. Cl. CPC H01M 4/587; H01M 4/366; H01M 4/364; H01M 2004/027; H01M 10/0568; H01M 10/058; H01M 10/0525

(57) ABSTRACT

A nonaqueous electrolyte secondary battery includes: a positive electrode; a negative electrode having a negative electrode active material mixture layer containing a negative electrode active material; a separator placed between the positive electrode and the negative electrode; and a nonaqueous electrolyte, where: the negative electrode active material includes coated graphite particles in which a surface of each graphite particle is covered with a coating layer containing first amorphous carbon and second amorphous carbon; and the negative electrode active material mixture layer contains the coated graphite particles and third amorphous carbon. The negative electrode active material mixture layer has an arithmetic-average surface roughness Ra of 2.8 μm to 3.4 μm, the separator has an elastic modulus of 15.1 MPa to 36.3 MPa, and the nonaqueous electrolyte contains a difluorophosphate salt and a lithium salt of an oxalate complex anion.

### CROSS REFERENCE TO RELATED APPLICATIONS

The present invention application claims priority to Japanese Patent Application No. 2017-189364 filed in the Japan Patent Office on Sep. 29, 2017, the entire contents of which are incorporated herein by reference.

### BACKGROUND OF THE INVENTION

### Field of the Invention

The present invention relates to a nonaqueous electrolyte secondary battery and a manufacturing method therefor.

### Description of Related Art

Nonaqueous electrolyte secondary batteries are used as driving sources of electric vehicles (EV) and hybrid electric vehicles (HEV, PHEV), for example.

As negative electrode active materials for such nonaqueous electrolyte secondary batteries, highly crystalline carbon materials, such as natural graphite and artificial graphite, or amorphous carbon materials are used.

To suppress a decrease in battery capacity of a nonaqueous electrolyte secondary battery after storage, Japanese Patent No. 5636622 (Patent Document 1) discloses that a difluorophosphate salt, such as lithium difluorophosphate, and a lithium salt of an oxalate complex anion, such as lithium bis(oxalato)borate, are added to a nonaqueous electrolyte.

Japanese Published Unexamined Patent Application No. 2014-35923 (Patent Document 2) discloses that lithium bis(oxalato)borate and/or lithium difluorophosphate are incorporated into a nonaqueous electrolyte of a nonaqueous electrolyte secondary battery.

Patent Document 2 also discloses that a calcined product of graphite particles surface-coated with pitch and carbon black is used as a negative electrode active material.

### BRIEF SUMMARY OF THE INVENTION

In nonaqueous electrolyte secondary batteries, further improved battery characteristics in terms of low-temperature regeneration characteristics and high-temperature cycle characteristics, for example, are desired.

An object of the present invention is to provide a nonaqueous electrolyte secondary battery having excellent low-temperature regeneration characteristics and high-temperature cycle characteristics.

A nonaqueous electrolyte secondary battery according to an aspect of the present invention includes: a positive electrode; a negative electrode having a negative electrode active material mixture layer containing a negative electrode active material; a separator placed between the positive electrode and the negative electrode; and a nonaqueous electrolyte, where: the negative electrode active material mixture layer contains coated graphite particles in which a surface of each graphite particle is covered with a coating layer containing first amorphous carbon and second amorphous carbon, and contains third amorphous carbon; the negative electrode active material mixture layer has an arithmetic-average surface roughness Ra of 2.8 μm to 3.4 μm; the separator has an elastic modulus of 15.1 MPa to 36.3 MPa; and the nonaqueous electrolyte contains a difluorophosphate salt and a lithium salt of an oxalate complex anion.

The nonaqueous electrolyte secondary battery according to an aspect of the present invention has excellent low-temperature regeneration characteristics and high-temperature cycle characteristics.

When a difluorophosphate salt and a lithium salt of an oxalate complex anion are incorporated into a nonaqueous electrolyte, storage properties and the like of a nonaqueous electrolyte secondary battery are improved. The present inventors, however, found through research and development that when a difluorophosphate salt and a lithium salt of an oxalate complex anion are incorporated into a nonaqueous electrolyte, low-temperature regeneration characteristics tend to be impaired and lithium becomes readily deposited on a negative electrode surface under harsh conditions. It is believed that when a difluorophosphate salt and a lithium salt of an oxalate complex anion are incorporated into a nonaqueous electrolyte, a coating as a resistive component is formed on a negative electrode surface, and consequently, electron conductivity of the negative electrode tends to be decreased. When electron conductivity of the negative electrode is decreased, it is believed that lithium ions are not absorbed smoothly into the negative electrode active material, and consequently, lithium becomes readily deposited on the negative electrode surface.

The nonaqueous electrolyte secondary battery according to an aspect of the present invention can enhance electron conductivity of the negative electrode by using, as the negative electrode active material, coated graphite particles in which a surface of each graphite particle is covered with a coating layer containing first amorphous carbon and second amorphous carbon, and by further incorporating third amorphous carbon as an conductive agent into the negative electrode active material mixture layer. Consequently, improved low-temperature regeneration characteristics and suppressed deposition of lithium can be achieved. Moreover, by setting an arithmetic-average surface roughness Ra of the negative electrode active material mixture layer to 2.8 μm to 3.4 μm and an elastic modulus of the separator to 15.1 MPa to 36.3 MPa, adhesion between the separator and the negative electrode can be enhanced. As the result, a stable short distance between the positive electrode and the negative electrode can be maintained, thereby achieving a battery configuration exhibiting further excellent low-temperature regeneration characteristics and further suppressed deposition of lithium. Moreover, in the configuration of a nonaqueous electrolyte secondary battery according to an aspect of the present invention, coatings derived from a difluorophosphate salt or a lithium salt of an oxalate complex anion are formed on the positive electrode and the negative electrode while electron conductivity of the negative electrode, as well as adhesion between the separator and the negative electrode, can be enhanced, thereby further effectively enhancing high-temperature cycle characteristics as well.

The above-mentioned coating layer is preferably a layer formed of the first amorphous carbon in which particles of the second amorphous carbon are dispersed. As the result, electron conductivity of the negative electrode can be enhanced further effectively.

The second amorphous carbon preferably has higher electric conductivity than the first amorphous carbon. As the result, electron conductivity of the negative electrode can be enhanced further effectively.

Preferably, the first amorphous carbon is a calcined product of pitch, the second amorphous carbon is carbon black, and the third amorphous carbon is carbon black.

A manufacturing method for a nonaqueous electrolyte secondary battery according to another aspect of the present invention is a manufacturing method for a nonaqueous electrolyte secondary battery containing: a positive electrode; a negative electrode having a negative electrode active material mixture layer containing a negative electrode active material; a separator placed between the positive electrode and the negative electrode; a nonaqueous electrolyte; and a battery case, includes: preparing the negative electrode having the negative electrode active material mixture layer which contains coated graphite particles in which a surface of each graphite particle is covered with a coating layer containing first amorphous carbon and second amorphous carbon, and which contains third amorphous carbon, where the negative electrode active material mixture layer has an arithmetic-average surface roughness Ra of 2.8 μm to 3.4 μm; placing the separator having an elastic modulus of 15.1 MPa to 36.3 MPa between the positive electrode and the negative electrode; and placing the nonaqueous electrolyte containing a difluorophosphate salt and a lithium salt of an oxalate complex anion inside the battery case.

The manufacturing method of a nonaqueous electrolyte secondary battery according to another aspect of the present invention can provide a nonaqueous electrolyte secondary battery having excellent low-temperature regeneration characteristics and high-temperature cycle characteristics.

The coated graphite particles are preferably obtained by attaching a member that forms the first amorphous carbon through calcination, and the second amorphous carbon or a member that forms the second amorphous carbon through calcination to each surface of the graphite particles, and calcining the graphite particles.

Preferably, the first amorphous carbon is a calcined product of pitch, the second amorphous carbon is carbon black, and the third amorphous carbon is carbon black.

A pressing step in which the separator is placed between the positive electrode and the negative electrode to form an electrode assembly and the electrode assembly is pressed is preferably included further. Through this step, concavo-convex portions of the negative electrode active material mixture layer are readily embedded in the separator, thereby enhancing adhesion between the negative electrode and the separator.

According to the present invention, a nonaqueous electrolyte secondary battery having excellent low-temperature regeneration characteristics and high-temperature cycle characteristics can be provided.

### BRIEF DESCRIPTION OF THE SEVERAL VIEWS OF THE DRAWINGS

FIG. 1 is a planar view of a positive electrode of a nonaqueous electrolyte secondary battery according to an embodiment.

FIG. 2 is a planar view of a negative electrode of the nonaqueous electrolyte secondary battery according to the embodiment.

FIG. 3 is a partial cross-sectional view of a rolled electrode assembly, which illustrates a stacked state of the positive electrode, a separator, and the negative electrode.

FIG. 4 is a perspective view of the nonaqueous electrolyte secondary battery according to the embodiment.

FIG. 5A is a cross-sectional view along VA-VA of FIG. 4.

FIG. 5B is a cross-sectional view along VB-VB of FIG. 4.

### DETAILED DESCRIPTION OF THE INVENTION

A configuration of a nonaqueous electrolyte secondary battery and a manufacturing method therefor according to the embodiment of the present invention will be described by using a prismatic battery 20 as an example of the nonaqueous electrolyte secondary battery.

### [Preparation of Positive Electrode]

A positive electrode active material mixture layer slurry is prepared by kneading lithium nickel cobalt manganese complex oxide (LiNi_{0.35}Co_{0.35}Mn_{0.30}O₂) as a positive electrode active material, polyvinylidene fluoride as a binder, carbon black as a conductive agent, and N-methyl-2-pyrrolidone as a dispersion medium. In this step, the mass ratio of lithium nickel cobalt manganese complex oxide:polyvinylidene fluoride:carbon black was set to 91:3:6. Subsequently, the positive electrode active material mixture layer slurry was applied to both surfaces of an aluminum foil (thickness 15 μm) as a positive electrode core, and then N-methyl-2-pyrrolidone as a dispersion medium was removed to form positive electrode active material mixture layers on the positive electrode core. After that, the positive electrode active material mixture layers were rolled by using a roller until a predetermined bulk density (2.65 g/cm³) was reached, and then cut into a predetermined size to yield a positive electrode 40.

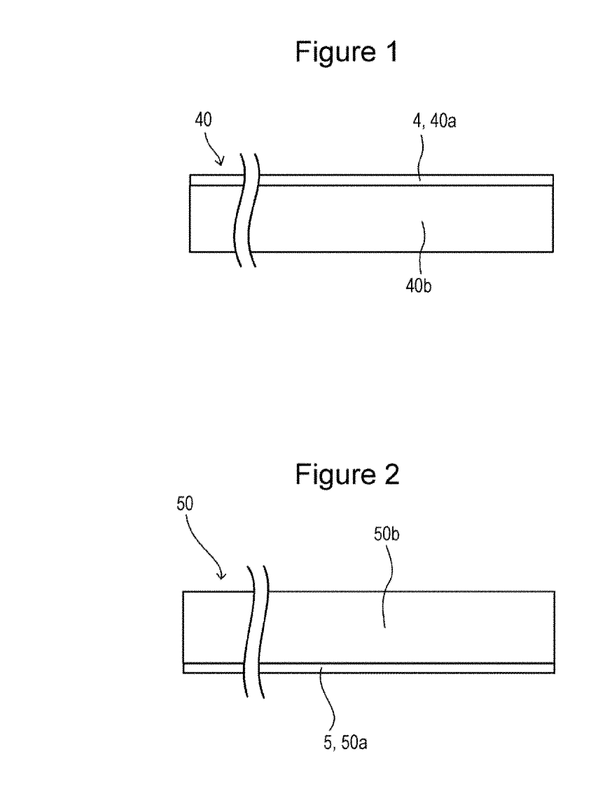

As illustrated in FIG. 1, the positive electrode 40 has positive electrode active material mixture layers 40b formed on both surfaces of a long positive electrode core 40a. At one end in the width direction of the positive electrode 40, a positive electrode core exposed portion 4 is provided in the longitudinal direction of the positive electrode 40.

### [Preparation of Coated Graphite Particles as Negative Electrode Active Material]

### <Mixing>

Carbon black and graphite particles that have been prepared by modifying natural graphite into spherical particles are mixed so as to attach carbon black to surfaces of the graphite particles. Subsequently, the resulting carbon black-coated graphite particles and pitch are mixed. Here, the graphite particles, pitch, and carbon black were mixed at a mass ratio of 88.4:4.7:6.9 to yield a mixture. In this step, the average particle size and BET specific surface area of carbon black were set to 90 nm and 45 m²/g, respectively.

### <Calcination>

Next, the mixture is calcined in an inert gas atmosphere at 1250° C. for 24 hours, and the calcined product is crushed and pulverized into coated graphite particles. Through the calcination, pitch is carbonized with a decrease in mass of 30%, whereas the graphite particles and carbon black are nearly unsusceptible to a decrease in mass. Consequently, the mass ratio of the graphite particles, the calcined product of pitch (carbonized product), and carbon black becomes 89.7:3.3:7 after calcination. In the coated graphite particles, carbon black particles are bonded to outer surfaces of the graphite particles by the calcined product of pitch (carbonized product). In other words, the coated graphite particles are in the state in which each graphite particle is surface-covered with a coating layer formed of the calcined product of pitch, and carbon black is dispersed in the coating layer. The median particle size D50 and BET specific surface area of the coated graphite particles were set to 9 μm and 8.8 m²/g, respectively.

### [Preparation of Negative Electrode]

The coated graphite particles prepared by the above-described method, carbon black as a conductive agent, carboxymethyl cellulose (CMC) as a thickening agent, and styrene-butadiene rubber (SBR) as a binder are kneaded together with water to prepare a negative electrode active material mixture layer slurry. Here, the mass ratio of the coated graphite particles, CMC, and SBR was set to 98.9:0.7:0.4. Moreover, the fraction of carbon black as a conductive agent was set to 4.5% relative to the coated graphite particles. Subsequently, the negative electrode active material mixture layer slurry was applied to both surfaces of a copper foil (thickness of 8 μm) as a negative electrode core and then dried to remove water, thereby forming negative electrode active material mixture layers on the negative electrode core. After that, the negative electrode active material mixture layers were rolled by using a roller until a predetermined bulk density (1.1 g/cm³) was reached, and then cut into a predetermined size to yield a negative electrode 50. In the negative electrode 50, the arithmetic-average surface roughness Ra of the negative electrode active material mixture layer was 3.1 μm. The arithmetic-average surface roughness Ra of the negative electrode active material mixture layer herein is a value defined according to JIS B 0601: 2001.

As illustrated in FIG. 2, the negative electrode 50 has negative electrode active material mixture layers 50b formed on both surfaces of a long negative electrode core 50a. At one end in the width direction of the negative electrode 50, a negative electrode core exposed portion 5 is provided in the longitudinal direction of the negative electrode 50.

### [Preparation of Rolled Electrode Assembly]

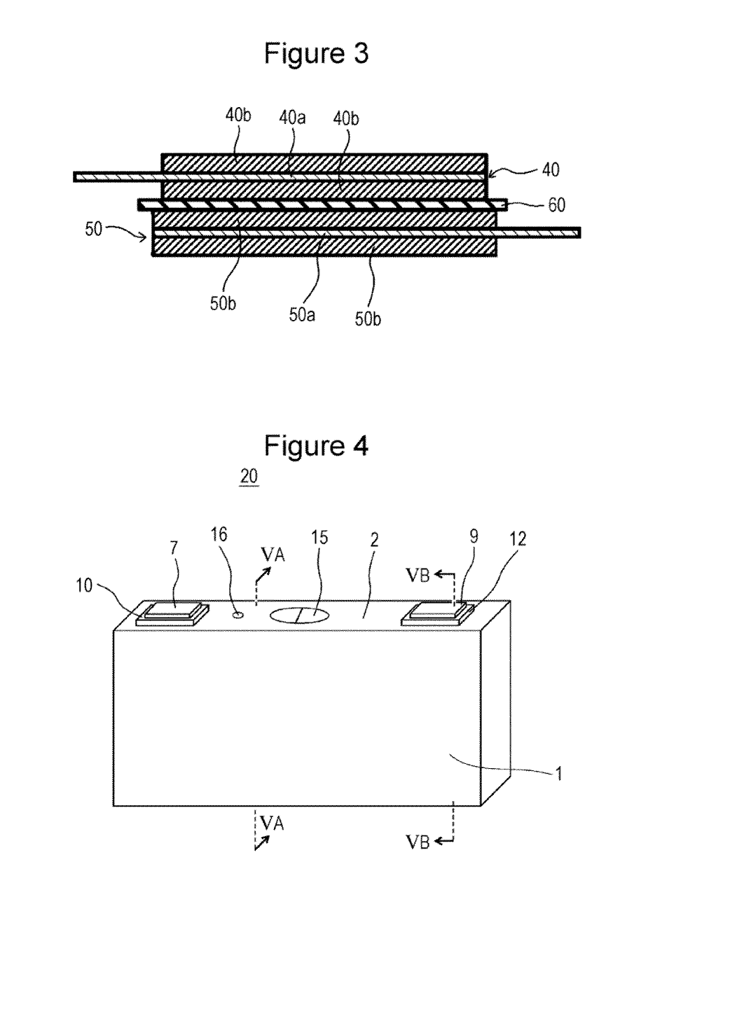

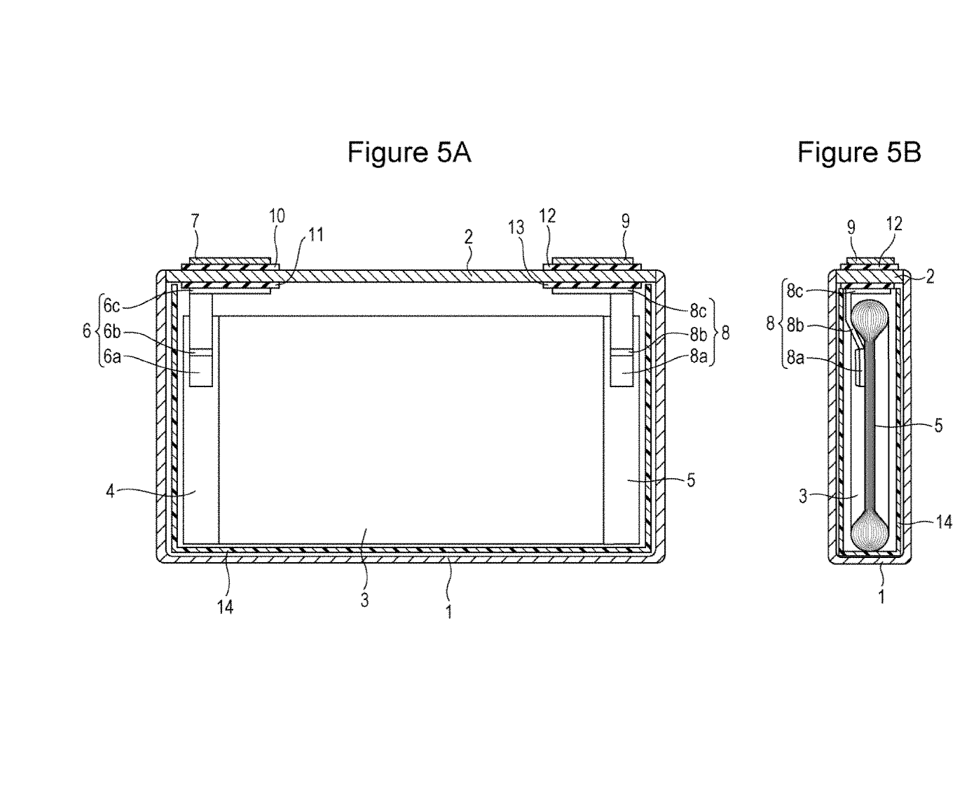

The long positive electrode 40 and the long negative electrode 50 prepared by the above-described methods were rolled via a long polyolefin separator 60 and press-formed into a flat shape. In this step, the elastic modulus of the separator 60 was 21.5 MPa. The resulting flat-rolled electrode assembly 3 includes the rolled positive electrode core exposed portion 4 at one end in the rolling axial direction and the rolled negative electrode core exposed portion 5 at the other end. FIG. 3 is a partial cross-sectional view of the rolled electrode assembly 3, which illustrates a layered state of the positive electrode 40, the separator 60, and the negative electrode 50.

### [Elastic Modulus of Separator]

An elastic modulus of the separator was determined by the method below.

The separator was cut into a rectangular test piece (60 mm×12.5 mm). In this step, the MD direction of the separator was set as a longitudinal direction of the test piece. The test piece was tensioned by using a tensile strength tester (AGS-X from Shimadzu Corporation) until the test piece broke in the longitudinal direction. Stress (MPa) during tensioning and elongated length (mm) of the test piece were measured. A value of the elongated length (mm) of the test piece divided by the original length (60 mm) of the test piece (elongated length of test piece/original length of test piece) was set as strain. Stress (MPa) during tensioning was plotted on the vertical axis and strain on the horizontal axis, and the elastic modulus of the test piece was calculated from the slope of linear approximation in a stress range of 10 MPa or higher. The elastic modulus (MPa) of the test piece was regarded as the elastic modulus (MPa) of the separator.

### [Preparation of Nonaqueous Electrolyte Solution]

A mixed solvent is prepared by mixing (at 25° C., 1 atmosphere) ethylene carbonate (EC), ethyl methyl carbonate (EMC), and dimethyl carbonate (DMC) at a volume ratio of 30:30:40. To the mixed solvent, 1.2 mol/L of LiPF₆, 0.05 mol/L of lithium difluorophosphate (LiPF₂O₂), and 0.10 mol/L of lithium bis(oxalato)borate (LiC₄BO₈) were added. Further, vinylene carbonate was added at a content of 0.3 mass % based on the total mass of a nonaqueous electrolyte solution to yield the nonaqueous electrolyte solution.

### [Fitting of Components to Sealing Plate]

An outer insulating member 10 is arranged on an outer-surface side of a battery surrounding a positive electrode terminal mounting hole (not shown) that is provided in a sealing plate 2. An inner insulating member 11 and a base portion 6c of a positive electrode current collector 6 are arranged on an inner-surface side of the battery surrounding the positive electrode terminal mounting hole (not shown) that is provided in the sealing plate 2. A positive electrode terminal 7 is then inserted from the outside of the battery into a through hole of the outer insulating member 10, the positive electrode terminal mounting hole, a through hole of the inner insulating member 11, and a through hole of the base portion 6c of the positive electrode current collector 6, and the leading end of the positive electrode terminal 7 is swaged on the base portion 6c of the positive electrode current collector 6. Consequently, the positive electrode terminal 7 and the positive electrode current collector 6 are fixed to the sealing plate 2. The swaged portion of the positive electrode terminal 7 is preferably welded to the base portion 6c. The positive electrode current collector 6 includes a connecting portion 6a to be connected to the positive electrode core exposed portion 4, the base portion arranged between the sealing plate 2 and the rolled electrode assembly 3, and a lead portion 6b that links the connecting portion 6a and the base portion 6c.

An outer insulating member 12 is arranged on the outer-surface side of the battery surrounding a negative electrode terminal mounting hole (not shown) that is provided in the sealing plate 2. An inner insulating member 13 and a base portion 8c of a negative electrode current collector 8 are arranged on an inner-surface side of the battery surrounding the negative electrode terminal mounting hole (not shown) that is provided in the sealing plate 2. A negative electrode terminal 9 is then inserted from the outside of the battery into a through hole of the outer insulating member 12, the negative electrode terminal mounting hole, a through hole of the inner insulating member 13, and a through hole of the base portion 8c of the negative electrode current collector 8, and the leading end of the negative electrode terminal 9 is swaged on the base portion 8c of the negative electrode current collector 8. Consequently, the negative electrode terminal 9 and the negative electrode current collector 8 are fixed to the sealing plate 2. The swaged portion of the negative electrode terminal 9 is preferably welded to the base portion 8c. The negative electrode current collector 8 includes a connecting portion 8a to be connected to the negative electrode core exposed portion 5, the base portion 8c arranged between the sealing plate 2 and the rolled electrode assembly 3, and a lead portion 8b that links the connecting portion 8a and the base portion 8c.

### [Fixing of Current Collector to Rolled Electrode Assembly]

The positive electrode current collector 6, in the connecting portion 6a, is connected to the rolled positive electrode core exposed portion 4 by welding. The negative electrode current collector 8, in the connecting portion 8a, is connected to the rolled negative electrode core exposed portion 5 by welding. Such connection by welding can be achieved by, for example, resistance welding, ultrasonic welding, and welding through irradiation by laser or the like.

### [Assembly of Prismatic Secondary Battery]

The rolled electrode assembly 3 to which the positive electrode current collector 6 and the negative electrode current collector 8 have been fixed is covered with a resin sheet 14 and inserted into a prismatic case 1. The sealing plate 2 and the prismatic case 1 are then welded to seal an opening of the prismatic case 1 with the sealing plate 2. Next, a nonaqueous electrolyte solution is fed through an electrolyte solution feed port provided in the sealing plate 2, and the electrolyte solution feed port is sealed with a sealing plug 16. A prismatic secondary battery 20 is thus manufactured. The battery capacity of the prismatic secondary battery 20 was set to 5.5 Ah.

The flat-rolled electrode assembly 3 is placed inside the prismatic case 1 so as to be oriented with the rolling axis parallel to the bottom part of the prismatic case 1. The electrically insulating resin sheet 14 is arranged between the prismatic case 1 and the rolled electrode assembly 3. A gas discharge valve 15 that breaks when pressure inside the prismatic case 1 reaches a predetermined value or higher to discharge gas inside the prismatic case 1 is provided in the sealing plate 2.

### Example 1

The prismatic secondary battery 20 manufactured by the above-described method is employed as a nonaqueous electrolyte secondary battery of Example 1.

### Examples 2 to 5 and Comparative Examples 1 to 11

Nonaqueous electrolyte secondary batteries were manufactured in a similar manner to the nonaqueous electrolyte secondary battery of Example 1 except for changing, as denoted by values in Table 1, the elastic modulus of the separator, the fraction of the calcined product of pitch in the coated graphite particles, the fraction of carbon black in the coated graphite particles, the fraction of carbon black as a conductive agent relative to the coated graphite particles, the arithmetic-average surface roughness Ra of the negative electrode active material mixture layer, the content of lithium bis(oxalato)borate in the nonaqueous electrolyte solution, and/or the content of lithium difluorophosphate in the nonaqueous electrolyte solution. These nonaqueous electrolyte secondary batteries are employed as the respective nonaqueous electrolyte secondary batteries of Examples 2 to 5 and Comparative Examples 1 to 11. In Table 1, “0” indicates that the corresponding substance is not contained.

### <Evaluation of Low-temperature Regeneration Characteristics>

Nonaqueous electrolyte secondary batteries of Examples 1 to 5 and Comparative Examples 1 to 11 were subjected to the following test.

Each nonaqueous electrolyte secondary battery was charged at 25° C. until the state of charge (SOC) reached 50%. Subsequently, each battery was charged at −30° C. and at each current of 1.6 It, 3.2 It, 4.8 It, 6.4 It, 8.0 It, and 9.6 It for 10 seconds to measure each battery voltage, and regeneration during charging was obtained by plotting the battery voltage against each current.

### <Evaluation of High-Temperature Cycle Characteristics>

Each nonaqueous electrolyte secondary battery of Examples 1 to 5 and Comparative Examples 1 to 11 was charged at 25° C. and at a constant current of 1 It to a battery voltage of 4.1 V. Subsequently, each battery was charged at a constant voltage of 4.1 V for 1.5 hours, given a rest for 10 seconds, and discharged at a constant current of 1 It to a battery voltage of 2.5 V. The discharge capacity at this point was set as the battery capacity before high-temperature cycles.

Next, each nonaqueous electrolyte secondary battery of Examples 1 to 5 and Comparative Examples 1 to 11 was subjected to 400 charge/discharge cycles at 60° C. below.

Each battery was charged at a constant current of 2 It (10 A) to a battery voltage of 4.1 V, given a rest for 10 seconds, and then discharged at a constant current of 2 It (10 A) to a battery voltage of 3.0 V. This cycle was set as one cycle.

Each nonaqueous electrolyte secondary battery of Examples 1 to 5 and Comparative Examples 1 to 11 after 400 cycles was charged at 25° C. and at a constant current of 1 It to a battery voltage of 4.1 V. Subsequently, each battery was charged at a constant voltage of 4.1 V for 1.5 hours, given a rest for 10 seconds, and then discharged at a constant current of 1 It to a battery voltage of 2.5 V. The discharge capacity at this point was set as the battery capacity after high-temperature cycles. A capacity retention rate after the high-temperature cycles was calculated according to the equation below.

Capacity retention rate=[battery capacity after high-temperature cycles (Ah)]/[battery capacity before high-temperature cycles (Ah)]

### <Evaluation of Resistance to Lithium Deposition>

Each nonaqueous electrolyte secondary battery of Examples 1 to 5 and Comparative Examples 1 to 11 was subjected to the following test.

Each nonaqueous electrolyte secondary battery was charged at 25° C. until the state of charge (SOC) reached 60%. Subsequently, each battery was charged at 25° C. and at 36 It for 10 seconds, discharged at 6.8 It for 50 seconds, and given a rest for 300 seconds. This procedure was set as one cycle, and each battery was subjected to 1,000 cycles.

Next, each nonaqueous electrolyte secondary battery was dismantled and visually inspected to determine whether lithium was deposited on the negative electrode surface.

Table 1 shows evaluation results of low-temperature regeneration characteristics, evaluation results of high-temperature cycle characteristics, and the presence or absence of lithium deposition for nonaqueous electrolyte secondary batteries of Examples 1 to 5 and Comparative Examples 1 to 11. In Table 1, evaluation results of low-temperature regeneration characteristics for the respective nonaqueous electrolyte secondary batteries are represented as relative values based on 100% for the low-temperature regeneration of the nonaqueous electrolyte secondary battery of Comparative Example 1. Similarly, in Table 1, evaluation results of high-temperature cycle characteristics for the respective nonaqueous electrolyte secondary batteries are represented as relative values based on 100% for the capacity retention rate of the nonaqueous electrolyte secondary battery of Comparative Example 1.

TABLE 1

| | | | | Fraction | Arithmetic- | | | | | |
|---|---|---|---|---|---|---|---|---|---|---|
| | | | | of | average | | | | | |
| | | Fraction | | carbon | surface | | | | | |
| | | of | | black as | roughness | Content of | | | | |
| | | calcined | Fraction | conductive | Ra of | lithium | Content | | | |
| | | product | of carbon | agent | negative | bis(oxalato)borate | of lithium | Low- | High- | |
| | Elastic | of pitch | black in | relative to | electrode | in | difluorophosphate | temperature | temperature | |
| | modulus | in coated | coated | coated | active | nonaqueous | in nonaqueous | regeneration | cycle | |
| | of | graphite | graphite | graphite | material | electrolyte | electrolyte | charac- | charac- | |
| | separator | particles | particles | particles | mixture | solution | solution | teristics | teristics | Deposition |
| | (MPa) | (mass %) | (mass %) | (mass %) | layer (μm) | (mol/L) | (mol/L) | (%) | (%) | of lithium |
| Ex. 1 | 21.5 | 3 | 7 | 4.5 | 3.1 | 0.1 | 0.05 | 122 | 119 | Absent |
| Ex. 2 | 21.5 | 1 | 9 | 5.5 | 3.4 | 0.1 | 0.05 | 124 | 120 | Absent |
| Ex. 3 | 21.5 | 5 | 5 | 3.5 | 2.8 | 0.1 | 0.05 | 117 | 117 | Absent |
| Ex. 4 | 36.3 | 3 | 7 | 4.5 | 3.1 | 0.1 | 0.05 | 117 | 116 | Absent |
| Ex. 5 | 15.1 | 3 | 7 | 4.5 | 3.1 | 0.1 | 0.05 | 125 | 120 | Absent |
| Comp. | 42.3 | 2 | 0 | 0 | 2.1 | 0 | 0 | 100 | 100 | Present |
| Ex. 1 | | | | | | | | | | |
| Comp. | 21.5 | 2 | 0 | 0 | 2.1 | 0 | 0 | 101 | 100 | Present |
| Ex. 2 | | | | | | | | | | |
| Comp. | 42.3 | 2 | 0 | 0 | 2.1 | 0.1 | 0.05 | 84 | 104 | Present |
| Ex. 3 | | | | | | | | | | |
| Comp. | 21.5 | 3 | 7 | 0 | 3.3 | 0 | 0 | 109 | 102 | Present |
| Ex. 4 | | | | | | | | | | |
| Comp. | 21.5 | 3 | 7 | 0 | 3.3 | 0.1 | 0.05 | 106 | 106 | Present |
| Ex. 5 | | | | | | | | | | |
| Comp. | 21.5 | 2 | 0 | 2 | 2 | 0 | 0 | 111 | 103 | Present |
| Ex. 6 | | | | | | | | | | |
| Comp. | 21.5 | 2 | 0 | 4.5 | 1.8 | 0 | 0 | 113 | 102 | Present |
| Ex. 7 | | | | | | | | | | |
| Comp. | 21.5 | 2 | 0 | 7 | 1.2 | 0 | 0 | 103 | 95 | Present |
| Ex. 8 | | | | | | | | | | |
| Comp. | 21.5 | 2 | 0 | 4.5 | 1.8 | 0.1 | 0.05 | 105 | 105 | Present |
| Ex. 9 | | | | | | | | | | |
| Comp. | 42.3 | 3 | 7 | 4.5 | 3.1 | 0.1 | 0.05 | 111 | 109 | Present |
| Ex. 10 | | | | | | | | | | |
| Comp. | 12.7 | 3 | 7 | 4.5 | 3.1 | 0.1 | 0.05 | 71 | 85 | Absent |
| Ex. 11 | | | | | | | | | | |

The nonaqueous electrolyte secondary batteries of Examples 1 to 5 exhibited low-temperature regeneration characteristics of as high as 117% to 125%, high-temperature cycle characteristics of as high as 116% to 120%, and no deposition of lithium. Consequently, the nonaqueous electrolyte secondary batteries of Examples 1 to 5 are nonaqueous electrolyte secondary batteries having excellent low-temperature regeneration characteristics, excellent high-temperature cycle characteristics, and high reliability without lithium deposition.

In each nonaqueous electrolyte secondary battery of Examples 1 to 5, lithium difluorophosphate and lithium bis(oxalato)borate are contained in the nonaqueous electrolyte, a calcined product of pitch and carbon black are contained in a coating layer of each coated graphite particle, and the coated graphite particles and carbon black as a conductive agent are contained in the negative electrode active material mixture layer. Further, each nonaqueous electrolyte secondary battery of Examples 1 to 5 has an arithmetic-average surface roughness Ra of the negative electrode active material mixture layer in the range of 2.8 μm to 3.4 μm and an elastic modulus of the separator in the range of 15.1 MPa to 36.3 MPa. Consequently, good coatings derived from lithium difluorophosphate and lithium bis(oxalato)borate are formed on the positive electrode and the negative electrode, thereby enhancing electron conductivity of the negative electrode and adhesion between the separator and the negative electrode. As the result, high-temperature cycle characteristics can also be enhanced effectively.

In each nonaqueous electrolyte secondary battery of Examples 1 to 5, a coating layer of each coated graphite particle contains a calcined product of pitch as first amorphous carbon and carbon black as second amorphous carbon. Carbon black has higher electric conductivity than a calcined product of pitch and thus enhances electron conductivity of the negative electrode further effectively. Moreover, since carbon black is dispersed in the layer formed of a calcined product of pitch, carbon black can be attached to graphite particle surfaces further effectively. For this reason, it is believed that electron conductivity of the coating layer is enhanced further effectively, and thus low-temperature regeneration characteristics are enhanced further effectively. In addition, carbon black is strongly attached to graphite particles by a calcined product of pitch.

In each nonaqueous electrolyte secondary battery of Comparative Examples 10 and 11, the negative electrode active material mixture layer contains coated graphite particles and carbon black as a conductive agent and has an arithmetic-average surface roughness Ra of 3.1 μm, and the nonaqueous electrolyte solution contains lithium difluorophosphate and lithium bis(oxalato)borate. In Comparative Example 10, however, the separator has an elastic modulus of as high as 42.3 MPa, whereas in Comparative Example 11, the separator has an elastic modulus of as low as 12.7 MPa. Consequently, Comparative Examples 10 and 11 exhibit inferior low-temperature regeneration characteristics and high-temperature cycle characteristics relative to Examples 1 to 5. Moreover, deposition of lithium was observed in Comparative Example 10.

Since the separator has an excessively high elastic modulus in Comparative Example 10, surface concavo-convex portions of the negative electrode active material mixture layer are less likely to be embedded in the separator. Consequently, it is believed that adhesion between the negative electrode and the separator was low, low-temperature regeneration characteristics and high-temperature cycle characteristics were unsatisfactory, and deposition of lithium was observed. In Comparative Example 11, since the separator has an excessively low elastic modulus, it is believed that lithium ions became difficult to pass through crushed pores of the separator, thereby impairing low-temperature regeneration characteristics and high-temperature cycle characteristics, compared with Comparative Example 1.

In the nonaqueous electrolyte secondary battery of Comparative Example 9, a coating layer on each graphite particle does not contain carbon black. Accordingly, electron conductivity of the negative electrode is not enhanced satisfactorily, and thus low-temperature regeneration characteristics and high-temperature cycle characteristics are not improved satisfactorily. Moreover, deposition of lithium is observed.

Comparison between Comparative Examples 1 and 2 reveals that low-temperature regeneration characteristics and high-temperature cycle characteristics hardly vary solely by changing elastic modulus of the separator.

In the nonaqueous electrolyte secondary battery of Comparative Example 3, the nonaqueous electrolyte solution contains lithium difluorophosphate and lithium bis(oxalato)borate. Accordingly, high-temperature cycle characteristics are improved relative to Comparative Example 1. Meanwhile, the coated graphite particles do not contain carbon black, and the negative electrode active material mixture layer does not contain carbon black as a conductive agent. For this reason, electron conductivity of the negative electrode is unsatisfactory, and thus low-temperature regeneration characteristics are unsatisfactory.

In the nonaqueous electrolyte secondary battery of Comparative Example 4, the nonaqueous electrolyte solution contains neither lithium difluorophosphate nor lithium bis(oxalato)borate. Moreover, the negative electrode active material mixture layer does not contain carbon black as a conductive agent. Accordingly, electron conductivity of the negative electrode is not enhanced satisfactorily, and low-temperature regeneration characteristics and high-temperature cycle characteristics are unsatisfactory since a good coating is not formed on the positive electrode or the negative electrode. Moreover, deposition of lithium is observed.

In the nonaqueous electrolyte secondary battery of Comparative Example 5, the nonaqueous electrolyte solution contains lithium difluorophosphate and lithium bis(oxalato)borate. The negative electrode active material mixture layer, however, does not contain carbon black as a conductive agent. Accordingly, electron conductivity of the negative electrode is not enhanced satisfactorily, and thus low-temperature regeneration characteristics and high-temperature cycle characteristics are unsatisfactory. Moreover, deposition of lithium is observed.

In the nonaqueous electrolyte secondary battery of Comparative Example 6, the negative electrode active material mixture layer contains carbon black as a conductive agent. The nonaqueous electrolyte solution, however, contains neither lithium difluorophosphate nor lithium bis(oxalato)borate. Moreover, the coated graphite particles do not contain carbon black. Accordingly, electron conductivity of the negative electrode is not enhanced satisfactorily, and low-temperature regeneration characteristics and high-temperature cycle characteristics are unsatisfactory since a good coating is not formed on the positive electrode or the negative electrode. Moreover, deposition of lithium is observed.

In the nonaqueous electrolyte secondary battery of Comparative Example 7, the negative electrode active material mixture layer contains carbon black as a conductive agent. The nonaqueous electrolyte solution, however, contains neither lithium difluorophosphate nor lithium bis(oxalato)borate. Moreover, the coated graphite particles do not contain carbon black. Accordingly, electron conductivity of the negative electrode is not enhanced satisfactorily, and low-temperature regeneration characteristics and high-temperature cycle characteristics are unsatisfactory since a good coating is not formed on the positive electrode or the negative electrode. Moreover, deposition of lithium is observed.

In the nonaqueous electrolyte secondary battery of Comparative Example 8, the coated graphite particles do not contain carbon black, and the nonaqueous electrolyte solution contains neither lithium difluorophosphate nor lithium bis(oxalato)borate. Accordingly, electron conductivity of the negative electrode is not enhanced satisfactorily, and low-temperature regeneration characteristics and high-temperature cycle characteristics are unsatisfactory since a good coating is not formed on the positive electrode or the negative electrode. Moreover, deposition of lithium is observed.

In the coated graphite particle, the content of a coating layer is preferably 0.5 mass % to 15 mass % and more preferably 1 mass % to 10 mass % based on a graphite particle. In the negative electrode active material mixture layer, the content of third amorphous carbon is preferably 0.5 mass % to 15 mass % and more preferably 1 mass % to 10 mass % based on the coated graphite particles.

The above-described Examples 1 to 5 illustrate an example in which carbon black (second amorphous carbon) is attached to the surface of graphite particles, then the graphite particles are mixed with pitch (material that forms first amorphous carbon after calcination/carbonization). As another method, it is possible to mix second amorphous carbon with a material that forms first amorphous carbon, and then attach the resulting mixture to graphite particle surfaces.

Here, the first amorphous carbon and the second amorphous carbon are different. The second amorphous carbon, however, may be the same as the third amorphous carbon.

Although a calcined product of pitch was used as the first amorphous carbon in the above-described Examples 1 to 5, a calcined product of a resin and a calcined product of heavy crude oil, for example, may also be used. Moreover, although carbon black was used as the second amorphous carbon, a conductive agent excluding carbon black, such as acetylene black or Ketjen black, may be used as well. Further, although carbon black was used for the third amorphous carbon as a conductive agent, a conductive agent excluding carbon black, such as acetylene black or Ketjen black, may be used as well.

In the present invention, a counter cation of the difluorophosphate salt is preferably selected from the group consisting of lithium, sodium, potassium, magnesium, and calcium. Lithium difluorophosphate is particularly preferred. Other compounds may be coordinated to lithium difluorophosphate. The content of lithium difluorophosphate in the nonaqueous electrolyte solution is preferably 0.01 to 0.2 mol/L, more preferably 0.01 to 0.1 mol/L, and further preferably 0.03 to 0.07 mol/L.

In the present invention, examples of the lithium salt of an oxalate complex anion include lithium bis(oxalato)borate, lithium difluoro(oxalato)borate, lithium tris(oxalato)phosphate, lithium difluorobis(oxalato)phosphate, and lithium tetrafluoro(oxalato)phosphate. The content of the lithium salt of an oxalate complex anion in the nonaqueous electrolyte solution is preferably 0.01 to 0.2 mol/L and more preferably 0.05 to 0.15 mol/L.

As materials for a positive electrode, a separator, an electrolyte solution, and the like, commonly known materials used for nonaqueous secondary batteries may be used. In the case of nonaqueous electrolyte secondary batteries, the following materials are preferably used.

As a positive electrode active material, a lithium transition metal complex oxide is preferably used. Examples of the lithium transition metal complex oxide include lithium cobalt oxide, lithium manganese oxide, lithium nickel oxide, lithium nickel manganese complex oxide, lithium nickel cobalt complex oxide, and lithium nickel cobalt manganese complex oxide. In addition, the above-mentioned lithium transition metal complex oxide added with Al, Ti, Zr, W, Nb, B, Mg, or Mo, for example, may also be used. Alternatively, olivine-type lithium iron phosphate may be used as well.

The positive electrode active material mixture layer preferably contains a positive electrode active material, a binder, and a conductive agent. As a binder, polyvinylidene fluoride (PVdF) is particularly preferred. As a conductive agent, carbon materials are particularly preferred. Further, a positive electrode core is preferably an aluminum foil or an aluminum alloy foil.

The bulk density of the positive electrode active material mixture layer after rolling is preferably 2 g/cm³ or more and more preferably 2.5 g/cm³ or more.

As a negative electrode active material, carbon materials that can adsorb/desorb lithium ions may be used. Examples of the carbon materials that can adsorb/desorb lithium ions include graphite, non-graphitizable carbon, graphitizable carbon, fibrous carbon, coke, and carbon black. Among the carbon materials, graphite is particularly preferred. Meanwhile, examples of non-carbonaceous materials include silicon, tin, alloys based thereon, and oxides based thereon.

Examples of nonaqueous solvents (organic solvents) for the nonaqueous electrolyte include carbonates, lactones, ethers, ketones, esters, and mixtures of two or more thereof. For example, a cyclic carbonate, such as ethylene carbonate, propylene carbonate, or butylene carbonate; and a linear carbonate, such as dimethyl carbonate, ethyl methyl carbonate, or diethyl carbonate, may be used. In particular, a mixed solvent of a cyclic carbonate and a linear carbonate is preferably used. Further, an unsaturated cyclic carbonate ester, such as vinylene carbonate (VC), may also be added to the nonaqueous electrolyte.

As electrolyte salts for the nonaqueous electrolyte, electrolyte salts commonly used in conventional lithium-ion secondary batteries may be used. Examples of the electrolyte salts include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and mixtures thereof. Among them, LiPF₆ is particularly preferred. An amount of an electrolyte salt dissolved in the above-mentioned nonaqueous solvent is preferably 0.5 to 2.0 mol/L.

As a separator, a porous separator formed of a polyolefin, such as polypropylene (PP) or polyethylene (PE), is preferably used. In particular, a separator having a three-layered structure of polypropylene (PP) and polyethylene (PE) (PP/PE/PP or PE/PP/PE) is preferably used. In addition, a heat-resistant layer composed of a binder and inorganic particles of alumina or the like may be provided on the separator. Alternatively, a polymer electrolyte may be used as a separator.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a positive electrode;
a negative electrode including a negative electrode active material mixture layer containing a negative electrode active material;
a separator placed between the positive electrode and the negative electrode; and
a nonaqueous electrolyte, wherein:
the negative electrode active material mixture layer contains coated graphite particles in which a surface of each graphite particle is covered with a coating layer containing first amorphous carbon and second amorphous carbon, and contains third amorphous carbon;
the negative electrode active material mixture layer has an arithmetic-average surface roughness Ra of 2.8 μm to 3.4 μm;
the separator has an elastic modulus of 15.1 MPa to 36.3 MPa; and
the nonaqueous electrolyte contains a difluorophosphate salt and a lithium salt of an oxalate complex anion.

2. The nonaqueous electrolyte secondary battery according to claim 1, wherein the coating layer is a layer formed of the first amorphous carbon in which particles of the second amorphous carbon are dispersed.

3. The nonaqueous electrolyte secondary battery according to claim 1, wherein the second amorphous carbon has higher electric conductivity than the first amorphous carbon.

4. The nonaqueous electrolyte secondary battery according to claim 1, wherein:
the first amorphous carbon is a calcined product of pitch;
the second amorphous carbon is carbon black; and
the third amorphous carbon is carbon black.

5. A manufacturing method for a nonaqueous electrolyte secondary battery including:
a positive electrode;
a negative electrode having a negative electrode active material mixture layer containing a negative electrode active material;
a separator placed between the positive electrode and the negative electrode;
a nonaqueous electrolyte; and
a battery case, the method comprising:
preparing the negative electrode having the negative electrode active material mixture layer which contains coated graphite particles in which a surface of each graphite particle is covered with a coating layer containing first amorphous carbon and second amorphous carbon, and which contains third amorphous carbon, the negative electrode active material mixture layer having an arithmetic-average surface roughness Ra of 2.8 μm to 3.4 μm;
placing the separator having an elastic modulus of 15.1 MPa to 36.3 MPa between the positive electrode and the negative electrode; and
placing the nonaqueous electrolyte containing a difluorophosphate salt and a lithium salt of an oxalate complex anion inside the battery case.

6. The manufacturing method for a nonaqueous electrolyte secondary battery according to claim 5, wherein the coated graphite particles are obtained by attaching a member that forms the first amorphous carbon through calcination, and the second amorphous carbon or a member that forms the second amorphous carbon through calcination to each surface of the graphite particles, and calcining the graphite particles.

7. The manufacturing method for a nonaqueous electrolyte secondary battery according to claim 5, wherein:
the first amorphous carbon is a calcined product of pitch;
the second amorphous carbon is carbon black; and
the third amorphous carbon is carbon black.

8. The manufacturing method for a nonaqueous electrolyte secondary battery according to claim 5, further comprising a pressing step in which the separator is placed between the positive electrode and the negative electrode to form an electrode assembly and the electrode assembly is pressed.
